(19) United States
(12) Patent Application Publication
(10) Pub. No.: US 2010/0083524 A1
(43) Pub. Date: Apr. 8, 2010

(54) Apparatus and process for drying items of laundry, using a heat pump and a heat exchanger

(75) Inventors: Markus Müller, Dresden (DE); René Paatzsch, Bad Gottleuba (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Haugerate GmbH, Munchen (DE)

(21) Appl. No.: 12/310,953

(22) PCT Filed: Aug. 17, 2007
(86) PCT No.: PCT/EP2007/058562

§ 371 Date: Mar. 12, 2009

(30) Foreign Application Priority Data
Sep. 13, 2006 (DE) 10 2006 042 991.5

(51) Int. Cl. F26B 3/02; D06F 58/04; F26B 21/00; F25B 21/02

(52) U.S. Cl. 34/443; 34/132; 34/79; 62/3.3

(57) ABSTRACT

An apparatus for drying laundry including a process air system for guiding a process air stream along a process air path having a treatment chamber therealong at which the process air stream contacts laundry, a first fan for moving the process air stream, a cooling location of a heat exchanger, a heating location of a heat pump downstream of the heat exchanger, and a heater in addition to the heat pump for heating the process air stream; and a secondary air system for guiding a secondary air stream along a secondary air path, the secondary air path including a second fan for imparting motion to the secondary air stream, a heating location of the heat exchanger, and a cooling location of the heat pump, and, within the secondary air path, the cooling location of the heat pump is located downstream of the heating location of the heat exchanger.

The invention relates to an apparatus for drying items of laundry comprising an essentially closed first channel system for channeling a process air stream which acts on the items of laundry, in which first channel system are arranged a treatment chamber for receiving items of laundry, a first fan for driving the process air stream, a first cooling channel of a heat exchanger and a second heating channel of a heat pump, with the second heating channel being located along the process air stream downstream of the first cooling channel, as well as an open second channel system for channeling a secondary air stream, in which second channel system are arranged a second fan for driving the secondary air stream, a first heating channel of the heat exchanger and a second cooling channel of the heat pump.

The invention also relates to a process for drying items of laundry by means of a process air stream essentially channeled in a closed first channel system and acting on the items of laundry located in a treatment chamber, which is cooled in a heat exchanger by a secondary air stream channeled in an open second channel system and then heated by a heat pump while cooling the secondary air stream.

Such a process and such an apparatus are derived from DE 43 30 456 C1. In this invention a process air stream circulates through the items of laundry to be dried to take up moisture, the heat exchanger for cooling down and condensing out the moisture as well as the heat pump and if necessary an additional heater for heating up. An open secondary air stream initially flows through the heat pump, where it is cooled, and then through the heat exchanger for cooling down the process air stream. Finally the secondary air stream returns to the environment of the device from which it was previously taken. The objective pursued with this process and this apparatus is that of improving the condensation performance of the heat exchanger and therefore of additionally cooling the secondary air stream by means of the heat pump. This is designed to achieve a more compact heat exchanger and thereby especially one that is easier to handle during cleaning. The heat pump operates with a circulating, cyclically alternating evaporated and condensed coolant.

An apparatus is described in EP 1 342 828 A2 which features two circuits for air streams which are coupled via a thermoelectric heat pump on the one hand and an air-air heat exchanger on the other hand for the exchange of heat with each other. A closed-circuit process air stream acting on the items of laundry is heated up in the heat pump and cooled down in the heat exchanger, a closed or open cooling air stream is cooled down in the heat pump and heated up in the heat exchanger. With the exception of any fans for driving the air streams, no further functional components are provided.

A tumble dryer is also disclosed in each of the documents EP 0 477 554 B1 and EP 1 108 812 B1, of which the disclosure is to be fully included in the disclosure of the current document. The channel system in which the air stream is guided is essentially closed—this means that the air stream essentially circulates without leakage when the apparatus is operating according to specification, but does not assume any significantly higher pressure than air in the environment of the device. The handling area for receiving the items of laundry is designed as a rotatable drum.

EP 0 467 188 B1, of which the disclosures are to be fully included in this disclosure, discloses a device for drying items of laundry in which a heat pump is provided instead of the conventional arrangement of cooler and heater. In this apparatus, instead of the cooler there is an evaporator, and instead of the heater there is a condenser for a working liquid circulating in an associated circuit of the heat pump. If necessary the channel system, in which the air stream circulates, can be connected to the environment by opening a flap, especially to let a part of the air stream heated up during operation out of the device and replace it by relatively cooler air from the environment.

A washing machine is disclosed in DE 14 10 206 A in which items of laundry cannot just be washed but can also be dried. A number of alternatives are illustrated for the additional devices required. In particular an electrical heating device for heating up a stream of air used for drying laundry items and a simple heat exchanger for cooling down the heated air stream after it has acted on the laundry items can be provided, a heat pump device can also be provided as an alternative. This heat pump can be embodied like the heat pump disclosed in EP 0 467 188 B1, it can also be a heat pump which operates with Peltier elements to make use of the thermoelectric effect.

DE 19 738 735 C2 discloses a device for drying items of laundry of the generic type described above, in which a heat pump is used which operates according to an absorber principle.

An apparatus for drying items of laundry disclosed in an abstract taken from the collection “Patent Abstracts of Japan” for JP 08 057 194 A which in its turn corresponds to the generic apparatus described above, contains in its channel system, as well as a thermoelectric heat pump with cold and warm branch, an additional heat exchanger connected upstream from the cold branch for cooling down the stream of air discharged from the items of laundry and an additional heating device connected downstream from the warm branch for further heating of the air stream before it acts on the items of laundry.

DE 35 09 549 A1 discloses a device for drying items of laundry which, as well as a heat pump, features a further heating device as well as additional heat transport devices such as gravitation heat pipes.

Details (in German) of fundamentals, function and application of Peltier elements can be found in documents which were able to be downloaded on Nov. 25, 2005 from Internet address http://www.quick-ohm.DE/waerme/download/Erlaeuterung-zu-Peltierelementen.pdf and http://www.quick-ohm.DE 19855245/waerme/download/Einbau.pdf.

The disadvantage of the apparatus and process described above in accordance with EP 1 342 828 A2 is that it is exclusively the heat pump that is available for heating the circulating process air stream. The heat pump must also pump the heat from its cooling channel to its heating channel over a considerable temperature difference—at the output of the cooling channel a temperature obtains which is lower than the temperature of the environment of the apparatus. The corresponding cooling down of the secondary air stream might possibly result in moisture condensing out in the secondary air stream, which under some circumstances can lead to the unwanted moisture imposing a strain on the apparatus and can lead to problems with hygiene.

One object of the invention to be disclosed below is to further develop the apparatus and the process in accordance with EP 1 342 828 A2 such that an improved heating of the process air stream and an improved operating point of the heat pump are obtained.

Specified for inventively solving this problem is an apparatus for drying items of laundry comprising an essentially closed first channel system for channeling a process air stream which acts on the items of laundry, in which first channel system are arranged a treatment chamber for receiving items of laundry, a first fan for driving the process air stream, a first cooling channel of a heat exchanger and a second heating channel of a heat pump, with the second heating channel being located along the process air stream downstream of the first cooling channel, as well as an open second channel system for channeling a secondary air stream, in which second channel system are arranged a second fan for driving the secondary air stream, a first heating channel of the heat exchanger and a second cooling channel of the heat pump, and in which apparatus a heater for heating the process air stream is arranged in the first channel system, and the second cooling channel lies along the secondary air stream downstream of the first heating channel.

Also specified for inventively solving this problem is a process for drying items of laundry by means of a process air stream essentially channeled in a closed first channel system and acting on the items of laundry located in a treatment chamber, which is cooled in a heat exchanger by a secondary air stream channeled in an open second channel system and then heated by a heat pump while cooling the secondary air stream, in which process the process air stream is heated by a heater arranged in the first channel system and the cooling of the secondary air stream is undertaken downstream of the heat exchanger.

According to the invention the process air stream is thus not only heated by the heat pump, but also by a special heater, which in accordance with conventional practice can be embodied as an electrical resistive heater. In addition the heat pump is incorporated into the second channel system for the secondary air stream such that it only cools the secondary air stream if the latter has taken up heat in the heat exchanger from the process air stream and thereby lost relative humidity. Therefore the heat exchanging components of the heat pump are only subjected to stress through moisture to a slight extent, from which an especially low tendency to corrosion and accordingly an advantage of a longer service life accrue.

In addition inventively—given a sufficiently good efficiency of the heat exchanger—the process air stream and the secondary air stream enter the heat pump with an especially small temperature difference in the corresponding channels, so that these can operate with a relatively small temperature difference averaged over their entire active volume and thus under especially favorable conditions. Good efficiency of the heat pump is thus guaranteed.

The heat brought into the process air stream by the heater is no longer more or less completely lost in the secondary air stream in the inventive apparatus or with the inventive method, but is recovered with the heat pump and fed back into the process air stream. Even if this recovery is not complete, a suitable layout of the heater, the heat exchanger and the heat pump can mean that the apparatus satisfies the requirements of the known energy consumption class A.

A preferred development of the apparatus is characterized by the heater being arranged along the process air stream immediately upstream of the treatment chamber. An unwanted loss of heat is kept down in this way.

It is further preferable for the first fan to be arranged along the process air stream immediately upstream of the heater; this keeps the thermal load on the fan especially low.

In another preferred development of the apparatus, in the second channel system, in which the secondary air cooling the process air stream is guided, the second fan is arranged along the secondary air stream upstream of the first heating channel. This arrangement is especially favorable for the construction of the apparatus.

It should be stated in relation to the preferred circuit arrangements of the first and second fan that these have been proven in prior art apparatus, but are not to be regarded as absolutely necessary for the functional success of the inventive apparatus. Other arrangements, for example of the first fan downstream instead of upstream of the drum or of the second fan downstream instead of upstream of the first heating channel are conceivable and, especially depending on arrangement of the components of the apparatus in a normal housing for a corresponding domestic appliance, also advantageous.

In an especially preferred development of the apparatus the first channel system on the outlet flow side of the first cooling channel has a separation compartment for separation of moisture from the process air stream; thus condensate arising in the heat exchanger can be separated and removed in a simple and useful way from the process air stream. The separation compartment, in accordance with current practice, can be connected constructionally to the heat exchanger. As it always has been, the most comprehensive possible separation of the condensate from the process air stream is an important criterion for achieving a high level of efficiency, since condensate remaining in the process air stream will evaporate again in the subsequent heating up of the process air stream, which demands additional energy and thus adversely affects the efficiency of the apparatus during operation.

Likewise especially preferred is a development in which the treatment chamber is rotatable and especially embodied as a drum.

Also especially preferred is a development of apparatus such that the heater and the heat exchanger are configured for drying the items of laundry without using the heat pump. This development is useful because it allows operation even without the heat pump as an otherwise unusual component, even if this comes at the expense of energy usage. The apparatus thus achieves a level of reliability that would be the norm for a conventional tumble dryer without depending on the characteristics of the heat pump used.

Preferably the heater is designed for a maximum heat output of at most 2700 W, especially around 2000 W.

Preferably the heat exchanger has a cooling power of at least 1000 W, especially around 1500 W.

For the heat pump of the apparatus a power consumption of between 200 W and 800 W, especially of about 500 W is preferred.

An especially preferred development of the apparatus features a heat pump with a thermoelectric pump unit. Such a pump unit is very compact and simple, and therefore especially suitable for use in an apparatus embodied as a tumble dryer. The especially low strain on the heat-exchanging components has an especially advantageous effect with such a heat pump, since in such cases the problem of avoiding adverse affects on the electrical components which, as a result of the concept, are immediately adjacent to the heat-exchanging components, is at a far lower level than with such a heat pump in a prior-art device.

Preferably a thermoelectric pump unit to be used in the invention has a power consumption of approximately 500 W, with the heater being configured in the corresponding apparatus for optional operation at a level with a power consumption of around 2000 W and at a low level with a power consumption of around 500 W, and with the heater and the pump unit being configured for control such that the pump unit operates jointly with the heater.

The fact that the heat pump operates simultaneously with the heater is generally a preferred development of the process and a preferred mode of operation of the apparatus. Thereby at each stage at which heat is fed to the process air stream, heat is also recovered which would otherwise be lost via the secondary air stream.

Exemplary embodiments of the invention are explained below with reference to the drawing. The figures of the drawing are to be considered as sketches; implementation of the associated teaching in concrete embodiments relies on the further knowledge of an appropriate person skilled in the art as well as the prior art documents cited above. The individual figures show:

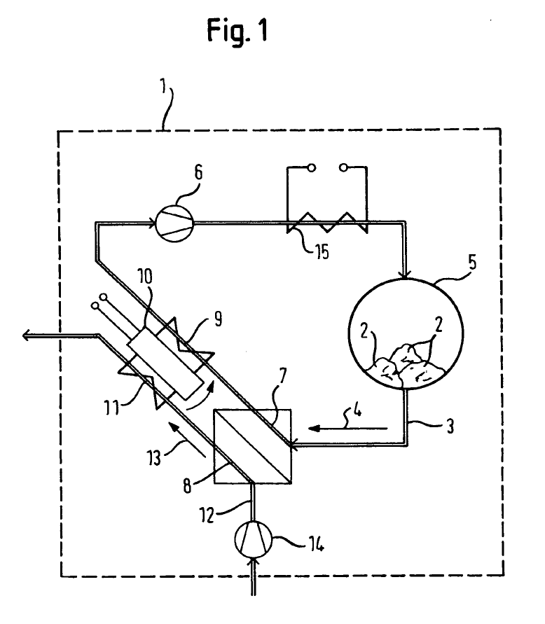

FIG. 1 a device for drying items of laundry with a heat pump and a heat exchanger;

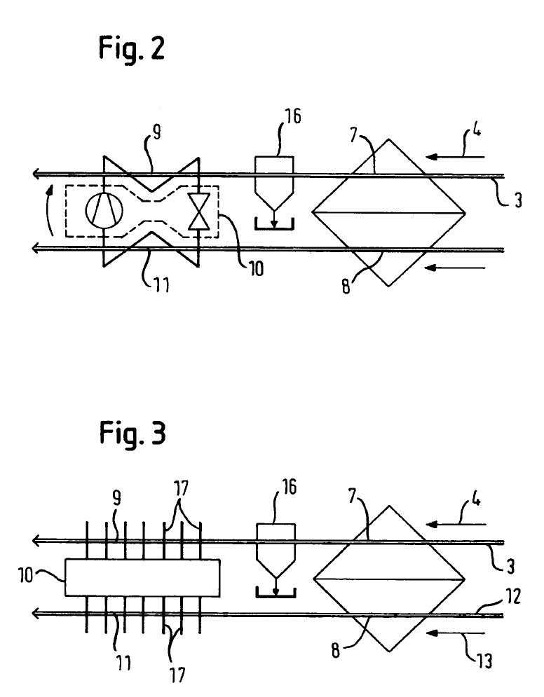

FIG. 2 a cross section of such a device, comprising a compressor heat pump;

FIG. 3 a cross section of a device in accordance with FIG. 1, comprising a thermoelectric heat pump.

The apparatus 1 for drying items of laundry 2 in accordance with FIG. 1 is an essentially closed first channel system 3 in which a process air stream 4 (symbolized by a straight arrow outside the channel system 3) circulates. To receive the items of laundry 2 a handling chamber 5 in the form of a rotatable drum 5 is provided. The items of laundry 2 are inserted into the drum 5 and the process air stream 4 acts on them there. The process air stream 4 is driven onto said items by a first fan 6 which is a component of the first channel system 3. After the process air stream 4 has taken up the moisture in the treatment chamber 5, it arrives in a first cooling channel 7 of a heat exchanger 7, 8. It is cooled off there so that the moisture that it is carrying condenses and through means which are not shown in FIG. 1 is separated from the process air stream 4 and discharged. A first heating channel 8 in the heat exchanger 7, 8 has a secondary air stream 13 (likewise symbolized by a straight arrow) which is driven by a second fan 14 applied to it in an open second channel system 12. In the heat exchanger 7, 8, the secondary air stream 13 takes heat out of the process air stream 4.

Downstream of the heat exchanger 7, 8 the process air stream 4 and the secondary air stream 13 arrive at a heat pump 9, 10, 11, comprising a second heating channel 9, in which the process air stream 4 flows, a second cooling channel 11, into which the secondary air stream 13 flows, and a pump unit 10, which applies them to internal heat exchangers of the heat pumps 10, 11 which are arranged in channels 9 and 11 and which heat up or cool down the air streams. In the second heating channel 9 of the heat pump 9, 10, 11 the process air stream 4 cooled in the heat exchanger 7, 8 is heated up again, and this is done by heat which, in accordance with the curved arrow, is taken from the secondary air stream 13 in the second cooling channel 11, as well as additionally by the waste heat created during the operation of the heat pump 10, 11. Thus the process air stream 4 is heated up again in the heat pump 9, 10, 11. It subsequently reaches the first fan 6 and from this a conventional heater 15. There it is heated up further and finally arrives back in the treatment chamber 5.

The secondary air stream 13 is taken from the environment of the apparatus 1 and arrives back in this environment after it has flowed through the second channel system 12. In the heat exchanger 7, 8 it is first heated up by heat removed from the process air stream 4. In the heat pump 9, 10, 11 the secondary air stream 13 will be cooled off again, so that the heat which was taken out of the process air stream 4 in the heat exchanger 7, 8, partly flows back into this each time.

FIG. 2 shows a section of the apparatus presented in FIG. 1. Shown in this figure are the heat exchanger 7, 8, the heat pump 9, 10, 11 and a separation compartment 16 for separation of condensate which has formed in the process air stream 4 after flowing through the first cooling channel 7. The heat pump 9, 10, 11 comprises two internal heat exchangers, which form the second heating channel 9 and the second cooling channel 11, and a pump unit 10, which contains a compressor and a choke. Accordingly the heat pump 9, 10, 11 is a compressor heat pump, as is known from a conventional refrigerator or freezer.

The configuration in accordance with FIG. 3 differs from the configuration depicted in FIG. 2, said configuration merely being referred to here rather than described once again, by a thermoelectric heat pump 9, 10, 11. The pump unit 10 contains a circuit with Peltier elements, which are to be understood as special electronic components. A Peltier element has two poles between which a temperature difference arises, if an electrical current of a pole flows to the other pole. The integration of such Peltier elements into a pump unit 10 is basically known and requires no explanation here. In the second heating channel 9 as well as in the second cooling channel 11 are located heat conductors 17, which are connected thermally conductively to the pump unit 10 and look after the exchange of heat between the channels 9 and 11 via the pump unit 10.

### LIST OF REFERENCE SYMBOLS

1 Apparatus, tumble dryer
2 Items of laundry
3 First channel system
4 Process air stream
5 Treatment chamber, drum
6 First fan
7 Heat exchanger, first cooling channel
8 Heat exchanger, first heating channel
9 Heat pump, second heating channel
10 Heat pump, pump unit
11 Heat pump, second cooling channel
12 Second channel system
13 Secondary air stream
14 Second fan
15 Heater
16 Separation compartment
17 Heat conductor

1-14. (canceled)

15. An apparatus for drying items of laundry, the apparatus comprising:
a process air system for guiding a process air stream along a process air path, the process air path including a treatment chamber at which the process air stream contacts laundry items, a first fan for imparting motion to the process air stream, a cooling location of a heat exchanger, a heating location of a heat pump downstream of the cooling location of the heat exchanger, and a heater in addition to the heat pump for heating the process air stream; and
a secondary air system for guiding a secondary air stream along a secondary air path, the secondary air path including a second fan for imparting motion to the secondary air stream, a heating location of the heat exchanger, and a cooling location of the heat pump, and, within the secondary air path, the cooling location of the heat pump is located downstream of the heating location of the heat exchanger.

16. The apparatus as claimed in claim 15 wherein the heater is disposed along the process air stream immediately upstream of the treatment chamber.

17. The apparatus as claimed in claim 16 wherein the first fan is disposed along the process air stream immediately upstream of the heater.

18. The apparatus according to claim 15 wherein the second fan is disposed along the secondary air stream upstream of the heating location of the heat exchanger.

19. The apparatus according to claim 15 wherein the process air system includes, downstream of the cooling location of the heat exchanger, a separation compartment for separation of moisture from the process air stream.

20. The apparatus as claimed in claim 15 wherein the treatment chamber is rotatable and is especially embodied as a drum.

21. The apparatus according to claim 15 wherein the heater and the heat exchanger are configured for drying items of laundry without using the heat pump.

22. The apparatus according to claim 15 wherein the heater is designed for a maximum heat output of at most about 2700 W, especially about 2000 W.

23. The apparatus according to claim 15 wherein the heat exchanger has a cooling power of at least about 1000 W, especially about 1500 W.

24. The apparatus according to claim 15 wherein the heat pump has a power consumption of between about 200 W and about 800 W, especially of about 500 W.

25. The apparatus according to claim 15 wherein the heat pump includes a thermoelectric pump unit.

26. The apparatus as claimed in claim 25 wherein the pump unit has a power consumption of about 500 W, and in which the heater is configured for optional operation at a high level with a power consumption of about 2000 W and at a low level with a power consumption of about 500 W, with the heater and the pump unit being configured for control such that the pump unit operates jointly with the heater.

27. A process for drying laundry items, the process comprising:
guiding a process air stream in an essentially closed first channel system in which the process air stream acts on laundry items located in a treatment chamber;
passing the process air stream through a cooling location of a heat exchanger;
cooling the heat exchanger via a secondary air stream that is passed into contact with the heat exchanger while being guided in an open second channel system;
heating the process air at a heating location of a heat pump downstream of the heat exchanger relative to a path along which the process air stream is guided
cooling the secondary air stream via extraction of heat from the secondary air stream by the heat pump such that the secondary air stream is cooled downstream of the heat exchanger relative to a path along which the secondary air stream is guided; and
heating the process air stream by a heater disposed in the first channel system.

28. The process as claimed in claim 27 wherein the heat pump operates at the same time as the heater.
